(19) United States
(12) Patent Application Publication
(10) Pub. No.: US 2002/0033542 A1
(43) Pub. Date: Mar. 21, 2002

(54) Water powered induced draft aerator

(76) Inventor: Gary S. McMillan, Elberta, AL (US)

Correspondence Address: George L. Williamson, P.O. Box 508, Fairhope, AL, 36533, US

(21) Appl. No.: 09/921,547

(22) Filed: Aug. 3, 2001

Related U.S. Application Data
(60) Provisional application No. 60/233,297, filed on Sep. 15, 2000.

(51) Int. Cl. B01F 3/04

(52) U.S. Cl. 261/25; 261/111

(57) ABSTRACT

The present invention discloses an induced aeration device which utilizes a housing containing a plurality of slats having an air inlet on its bottom and an air outlet on its top. The housing contains a horizontally rotatable water distribution arm having horizontal water outlets directed in a reverse direction to that of rotation so that the distribution arm turns in response to the force created by the water outlet jets. A fan is disposed on top of the water distribution arm so that the fan turns with the water distribution arm. Further, the fan is effectively sized to induce the flow of air through the housing in sufficient quantity to aerate the influent water flow.

This application benefit of Provisional Application Serial No. 60/223,297 filed on Aug. 7, 2000.

### BACKGROUND OF THE INVENTION

1. Field of the Invention

The present invention generally relates to aeration devices and, more particularly, is concerned with an induced draft aeration device.

2. Description of the Prior Art

Induced draft aerators have long been used in treatment of water for the removal of volatile gasses and the oxidation of dissolved minerals commonly found in water. Common uses are for the removal of gasses such as carbon dioxide, hydrogen sulfide, and radon as well as the oxidation of iron and manganese for later removal by other treatment processes.

An induced draft aerator operates by breaking water flow into small droplets that fall through the air to create a much greater contact area between the water and the air than normally occurs. This is accomplished by introducing the water into the top of a somewhat tall vessel containing many slats through which the water falls by gravity. Water splashing through the many levels of slats is broken into small droplets and is thereby aerated to allow volatile gasses to be released and to oxidize dissolved iron and manganese. A fan located at the top of the vessel draws or induces air from vents located near the bottom of the column up through the slats to provide a constant flow of fresh air around the water droplets. Air along with the removed gasses is exhausted through the fan.

Previous designs utilize an electric motor to power a fan or blower. Problems that typically occur with this type of aerator are usually associated with the fan. Local power outages may cause the fan to not operate. Control system failure may not start the fan when required. Operator error may have the fan off line when it is needed. These and other potential problems that can cause the fan to not operate will result in less effective aeration and lower quality treated water.

A search of the prior art has disclosed the following art:

In U.S. Pat. No. 4,710,324 dated Dec. 1, 1987, Vesnaver disclosed a device for aerating water comprising (1) a fan within a pumping chamber for drawing air through an intake port and forcing air out an exhaust port therein, (2) a fan enabling means located outside the pumping chamber for moving the fan so that air is drawn through the intake port and out the exhaust port, (3) a means for insulating the pumping chamber from the heat created by the fan enabling means, and (4) a means for dispersing the air flowing out of the exhaust port and into water.

In U.S. Pat. No. 4,796,319, dated Dec. 11, 1990, Eberhardt, et al., disclosed a portable water-driven fan for firefighting applications utilizing positive pressure ventilation. A unit including a water-powered turbine and a fan is constructed to be light in weight and compact and is capable of delivering a large volume of air sufficient for positive pressure ventilation. The unit is provided with a plurality of spray nozzles which enables the unit to deliver a water mist along with the air.

In U.S. Pat. No. 4,907,654, dated Mar. 13, 1990, Eberhardt disclosed a fan system for use in firefighting applications employing positive pressure ventilation which includes a lightweight portable fan having a water-powered turbine as its driver. A flow control valve is operable to set the system to operate in a plurality of modes including a mode wherein an air stream and a water mist can be directed toward the fire.

In U.S. Pat. No. 5,779,999, dated Jul. 14, 1998, Laslo disclosed a method for scrubbing flue gases utilizing a spray tower for removing acidic gases and particulate matter from flue gases produced by processing operations of the type carried out in utility and industrial facilities. The spray tower is equipped with a tank that serves as a reservoir for an alkaline slurry used to remove acidic gases and particulate matter from the flue gases. The slurry is pumped from the tank to spraying devices located within the tower. The spray tower further includes an internal structure that enables the slurry to be oxidized and gently agitated within a limited region of the tank and without the requirement for two separate aeration and agitation devices. As a result, the construction, operation and maintenance costs of the spray tower are significantly reduced as compared to prior art spray towers.

In U.S. Pat. No. 5,378,267, dated Jan. 3, 1995, Bros, et al., disclosed a modular air stripper apparatus comprised of a plurality of stacked air stripping chambers.

In U.S. Pat. No. 4,906,338, dated Mar. 6, 1990, DeLoach disclosed a method for removing the volatile constituents from gasoline and volatile organic chemicals from contaminated potable water when a fluid including a gasoline-water mixture and when contaminated potable water is introduced into a vertical tower which includes the steps of flowing the gasoline-water fluid and the water downward in a tower over and in contact with media trays stacked in courses in the tower. The media trays, either circular or square, fit closely within the tower inner wall, such trays are aluminum or molded plastic frames one-inch by one-inch angles on-eighth inch thick, with a plurality of one and one-half inch wide slats one-quarter of an inch thick on the top of the frame; the slats being spaced apart not less than one-half inch nor more than three-quarters of an inch. The stacked trays are so arranged in courses that the slats of trays of alternate courses, but the slats of intermediary trays are disposed at ninety degrees to the slats of trays in the alternate courses. A column of air flowing upward through the media trays entrains the volatile constituents released from the gasoline, and the volatile organic chemicals liberated from the water, when the fluid contacts the media in the tower. A structure for exhausting the air and entrained volatile constituents is provided, and a structure is provided for removing fluid from the bottom of the tower.

While these aeration devices may be suitable for the purposes for which they were designed, they would not be as suitable for the purposes of the present invention, as hereinafter described.

### SUMMARY OF THE PRESENT INVENTION

The present invention discloses an induced aeration device which utilizes a housing containing a plurality of slats having an air inlet on its bottom and an air outlet on its top. The housing contains a horizontally rotatable water distribution arm having horizontal water outlets directed in a reverse direction to that of rotation so that the distribution arm turns in response to the force created by the water outlet-jets. A fan is disposed on top of the water distribution arm so that the fan turns with the water distribution arm. Further, the fan is effectively sized to induce the flow of air through the housing in sufficient quantity to aerate the influent water flow.

Various advantages of the present invention follow: By eliminating the need for electricity, this aerator should offer lower installation and operation costs. By not relying on electricity, this design is not effected by power outages Additionally, no controls are required to start an electric blower when flow is present since the flow itself powers the blower. Since there are no controls or power switches, a source of potential operator error is also eliminated.

The action of the spray jets provides significant aeration of the flow in addition to the aeration that occurs in the slats. The motion of the distribution arms to evenly distribute the flow over the slats replaces large perforated trays commonly found on existing designs. A larger fan area produces high airflow without the higher velocities present in most electric blowers. By minimizing high air velocities in the fan section, greater airflow can be utilized without blowing mist out of the top of the aerator. These factors together result in an induced draft aerator that is more efficient, easier and less expensive to install, maintain, and operate than designs currently available.

An object of the present invention is to provide an induced draft water aerator that requires no electrical power or controls to operate. The key feature of this invention that distinguishes it from similar equipment currently available is that it utilizes the water itself to turn a mechanism that both distributes water within the aerator and provides airflow through the water to enhance aeration. This eliminates all problems associated with an electric motor that is normally used to induce airflow. It is unaffected by power outages or operator error. Furthermore, no control system is required to activate the fan whenever there is flow since the flow itself turns the fan. The large fan diameter provides a high airflow volume without problems associated with the high air velocities produced by smaller electric blowers. Additional benefits include lower installation and operational costs since no electrical or control systems are required.

The foregoing and other objects and advantages will appear from the description to follow. In the description reference is made to the accompanying drawings, which form a part hereof, and in which is shown by way of illustration, specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claim.

### BRIEF DESCRIPTION OF THE DRAWINGS

In order that the invention may be more fully understood, it will now be described, by way of example, with reference to the accompanying drawings in which:

FIG. 1 is an elevation view of the present invention showing the front of the aerator housing.

FIG. 2 is an elevation view of the present invention showing the right side of the aerator housing.

FIG. 3 is a cross section of the present invention showing the interior of the aerator.

FIG. 4 is a plan view of the present invention showing a partial cut-away view.

FIG. 5 is a side elevation view of the present invention showing the basic operating principle of the invention.

FIG. 6 is a sectional view of the rotating mechanism showing the internal portions of the fan/spray jet assembly.

### LIST OF REFERENCE NUMERALS

With regard to reference numerals used, the following numbering is used throughout the drawings.

10 present invention

12 housing

14 water inlet

16 water outlet

18 air inlet

20 air outlet

22 access door

24 solid top

26 legs

28 fan/spray jet assembly

30 elbow

32 spray nozzles

34 distribution arm

36 central hub

38 fan

40 slats

41 slat coupling

42 slat support

44 support beam

46 drip edge

48 water

50 arrow

52 stationary visor

54 hole

56 upper sleeve bearing

58 lower sleeve bearing

60 weep holes

62 upper thrust bearing

64 lower trust bearing

68 nut

70 washer

### DETAILED DESCRIPTION OF THE PREFERRED EMBODIMENTS

The following discussion describes in detail one embodiment of the invention and several variations of that embodiment. This discussion should not be construed, however, as limiting the invention to those particular embodiments. Practitioners skilled in the art will recognize numerous other embodiments as well. For a definition of the complete scope of the invention, the reader is directed to the appended claims.

By way of general explanation, and as will be explained in detail hereinafter, the present invention is essentially an improvement over similar equipment that is currently available for the reduction in levels of soluble gasses and the oxidation of dissolved iron in water. The design and construction of this invention is similar to other designs with one major exception. This invention utilizes a blower that is turned by the flow of water coming into the unit instead of electric motors. The outward physical appearance of the unit differs slightly from other induced draft aerators due to a larger diameter fan on the top of the unit.

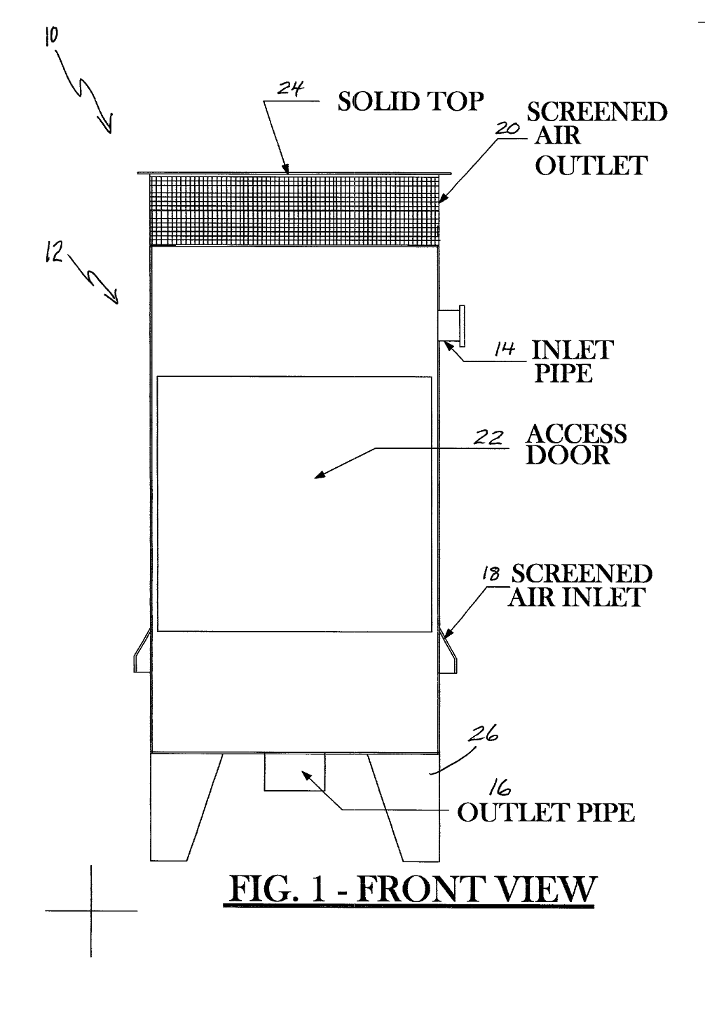

Turning to FIG. 1, shown therein is a front view of the present invention 10 showing the front of the aerator housing 12. It indicates the relative location of the raw water inlet pipe 14, treated water outlet pipe 16, screened air intake vents 18 and air outlet 20, and access door 22. Also shown are the solid top 24 and legs 26 of the housing.

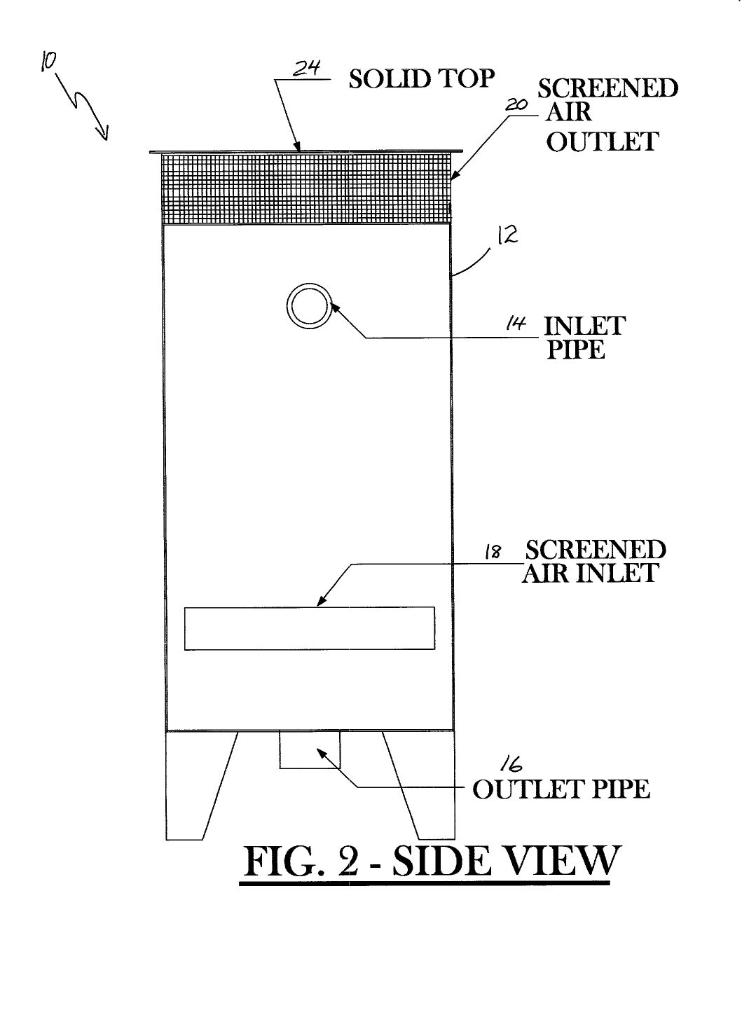

Turning to FIG. 2, shown therein is a side view of the present invention 10 showing the right side of the aerator housing 12. This view shows the relative size of the screened air inlets 18 and outlets 20. Other elements previously disclosed are also shown.

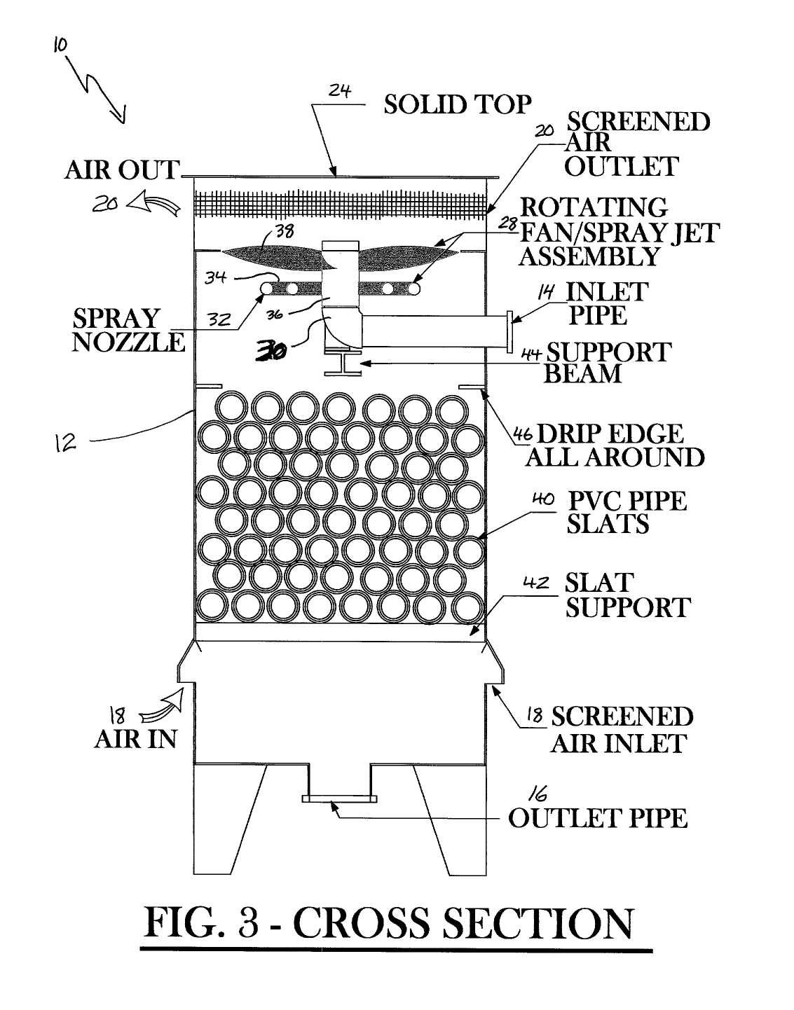

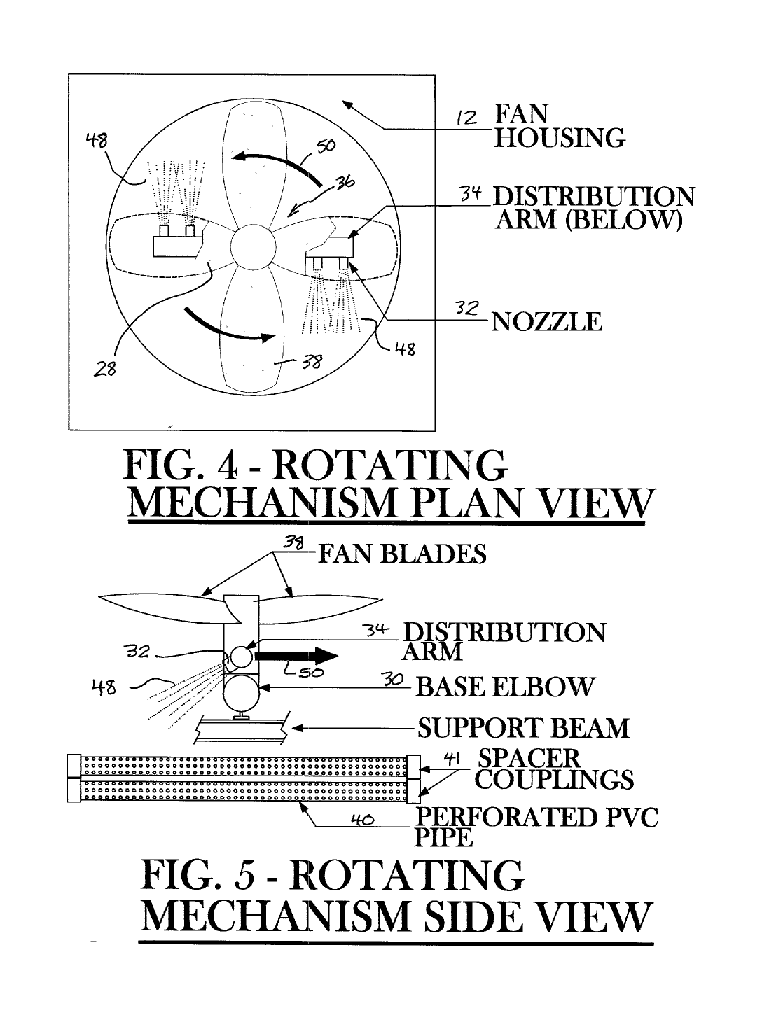

Turning to FIG. 3, shown therein is a cross section of the present invention 10 showing the inner working parts of the aerator 10. Raw water enters the aerator 10 through the inlet pipe 14 on the right side of the aerator and turns up at elbow 30 into the rotating fan/spray jet assembly 28. Water exits the fan/spray jet assembly through multiple spray nozzles 32 located along distribution arm 34 extending from the rotatable central hub 36. Thrust from these nozzles 32 cause the assembly 28 (see FIG. 4). The circular movement of the nozzles 32 evenly distributes the water over the slats 40 while the turning fan blades 38 attached to the same central hub 36 cause air to be pulled through the slats 40. The water passes downwardly through the slats 40 and is collected in the bottom of the aerator housing 12 where it exits through the outlet pipe 16. Also shown are the screened air inlet 18 and outlet 20, slat structural support 42, solid top 24, support beam 44 for the fan/spray jet assembly and a drip edge 46.

Turning to FIG. 4, shown therein is a rotating mechanism plan view of the present invention showing the housing 12 and the basic operating principle of the invention. Water 48 passes from a center hub 36 through distribution arms 34 to nozzles 32 pointed tangential to the direction of rotation shown by arrows 50 of the assembly 28. The thrust of the water jets 32 causes torque which results in movement of the fan blades 38 attached to the common hub 36. The pitch of the fan blades 38 causes air to be drawn up through the slats and ejected through the air outlet as previously discussed.

Turning to FIG. 5, shown therein is a side view of the rotating mechanism of the present invention showing a side view of the operation of a water nozzle or jet 32 spraying water 48 onto the slats 40 below. Slats 40 can be configured in a number of ways as would be done in the standard manner by one skilled in the art. The slats 40 shown consist of perforated PVC pipe with couplings 41 on each end. When stacked, the couplings 41 provide spaces between the pipe slats 40 for air and water flow. The use of perforated pipe provides additional surface area for the water 48 to be dispersed for more efficient aeration. The nozzles 32 are directed angularly downwardly towards the PVC slats 40 to minimize the amount of water spray that enters the fan 38 unit above. Other elements previously disclosed are also shown.

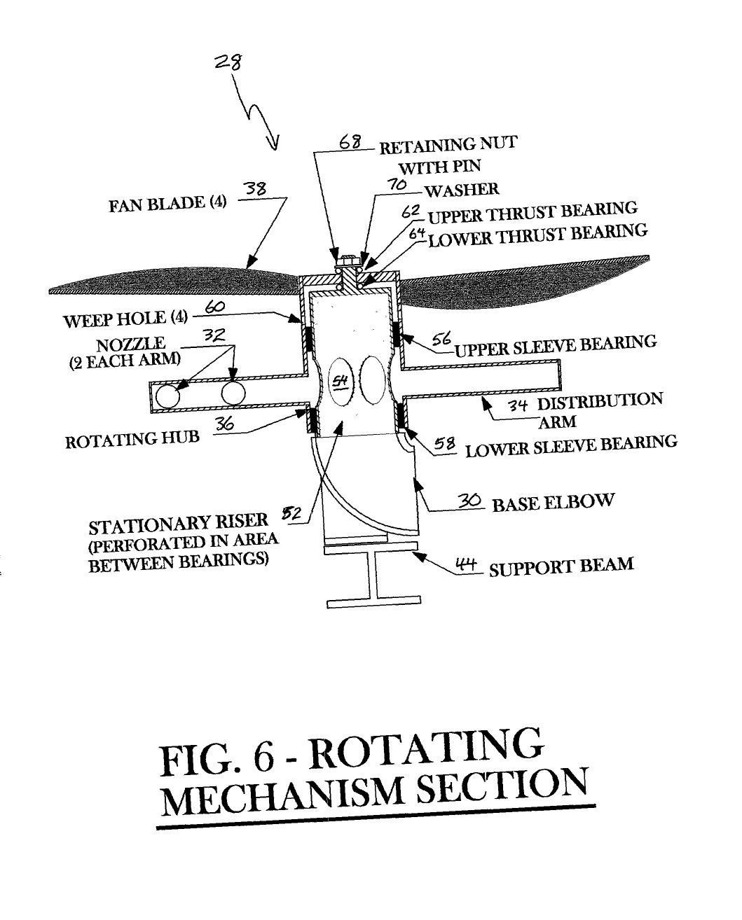

Turning to FIG. 6, shown therein is a view of the rotating mechanism section showing the internal working parts of the fan/sprayjet assembly 28. Water enters the stationary riser 52 through the base elbow. Holes or perforations 54 in the stationary riser 52 allow the water to flow to the spray nozzles 32 through the distribution arms 34 that are part of the rotating assembly along with the fan 38 above. Lateral support for the rotating hub 36 is provided by upper 56 and lower 58 sleeve-type bearings above and below the perforated zone 54 of the stationary riser 52. Weep holes 60 in the rotating hub 36 are provided to release water that passes by the water lubricated upper sleeve bearing 56. Water leakage past the sleeve bearings 56 is expected and considered inconsequential. Vertical thrust is carried by the upper 62 and lower 64 thrust bearings located at the top of the assembly 28. The primary thrust load is the result of the weight of the rotating mechanism and the water in the distribution arms. The weep hole configuration keeps the thrust bearings out of the water flow. The entire rotating assembly 28 can be lifted from the stationary riser 52 by the removal of the single retaining nut 68 with washer 70. The weight of the entire assembly is carried by a support beam 44 that is attached on each end to the walls and frame of the aerator structure. The base elbow 30 is also shown. It should be clear that water entering the assembly from an outside source causes the assembly 28 to rotate. This rotation both causes airflow through the aerator and distributes the flow evenly across the aeration slats 40.

The present invention may be constructed of aluminum, stainless steel, coated carbon steel, or fiberglass. Stainless steel could be used to construct the fan/spray jet assembly where additional strength is required to handle the forces of water impact. Slats shown are fabricated from PVC pipe. Other slat arrangements using PVC or other materials should be equally effective. The outer housing and structural components could be welded and could feature hinged access doors or removable panels to allow access and removal of all internal parts.

Summarizing the operation of the present invention, it should be clear that induced draft aerators operate by splashing a flow of water on the physical surfaces within the aerator into many small droplets. This greatly increases the area of the water in contact with air to allow volatile gasses to be released into the air and to provide oxygen for the oxidation of dissolved iron. Water flows into the side of the aerator and into the distribution arms of the rotating fan/spray jet assembly. Thrust from the water passing through nozzles on the distribution arms causes rotation of the fan/spray jet assembly. The moving distribution arms evenly distribute the flow over the aeration slats below. Water cascades through the slats to the bottom of the aerator where it collects and flows by gravity through outlet piping. Fresh air drawn into the aerator by the motion of the fan passes through screened air intake vents near the bottom of the aerator. The air moves upward around the slats to the fan. Airflow from the fan is exhausted through the screened outlet at the top of the aerator. The majority of the aeration occurs during the time the water cascades through the slats. However, significant aeration also occurs as the water is sprayed onto the slats from the nozzles.

It will be clear to one skilled in the art that the present invention could be adapted to be used in other industrial applications, e.g., for use in a cooling tower for reducing the temperature of the process water passing therethrough.

What is claimed to be new and desired to be protected by Letters Patent is set forth in the appended claims:

I claim:

1. An apparatus for inducing air flow through a water aerator, comprising:
a) a housing, said housing having a top and a bottom;
b) an air inlet disposed in said bottom of said housing;
c) an air outlet disposed in said top of said housing;
d) a plurality of slats disposed in said housing between said air inlet and said air outlet;
e) a water inlet,
f) means for rotatably distributing water disposed internal said housing whereby water is distributed over the slats so as to aerate the water;
g) means for a fan disposed on said means for rotatably distributing water whereby the fan turns and induces air flow from the air inlet to the air outlet; and,
h) a water outlet from said housing.

2. In a water aerator having a housing, the housing having an air inlet and an air outlet, further having a water inlet and a water outlet, further having a plurality of slats disposed internal the housing so that water will flow downwardly over the slats so that the water is aerated, the improvement comprising:
a) means for rotatably distributing water disposed internal said housing whereby water is distributed over the slats so as to aerate the water; and,
b) means for a fan disposed on said means for rotatably distributing water whereby the fan turns and induces airflow from the air inlet to the air outlet.

3. In a cooling tower having a housing, the housing having an air inlet and an air outlet, further having a water inlet and a water outlet, further having a plurality of slats disposed internal the housing so that water will flow downwardly over the slats so that the water is cooled, the improvement comprising:
a) means for rotatably distributing water disposed internal said housing whereby water is distributed over the slats so as to cool the water; and,
b) means for a fan disposed on said means for rotatably distributing water whereby the fan turns and induces airflow from the air inlet to the air outlet.
